(19) United States
(12) Patent Application Publication
(10) Pub. No.: US 2025/0312820 A1
(43) Pub. Date: Oct. 9, 2025

(54) ALLOY WHEEL WITH TINTED OVERCOATING

(71) Applicant: SUPERIOR INDUSTRIES INTERNATIONAL INC., Southfield, MI (US)

(72) Inventors: Thomas Schwing, Hickory Creek, TX (US); Henry Clay Chenault, III, Fayetteville, AR (US)

(21) Appl. No.: 18/865,212

(22) PCT Filed: May 10, 2023
(86) PCT No.: PCT/US2023/021783

§ 371 Date: Nov. 12, 2024

Related U.S. Application Data
(60) Provisional application No. 63/340,654, filed on May 11, 2022.

(51) Int. Cl. B05D 7/00; B05D 5/06; B60B 3/10

(52) U.S. Cl. CPC B05D 7/53; B05D 5/06; B60B 3/10; B60B 2310/616

(57) ABSTRACT

A vehicle wheel includes a face portion and rim portion defining a wheel surface. The face portion includes a plurality of spokes extending radially outwardly from a central portion to the rim portion interconnecting the face portion to the rim portion. A translucent polymer coating defines an outermost coating of the surface of the wheel where the translucent polymer coating is tinted for reflecting a first portion of light illuminating the wheel and allowing a second portion of light to pass through the translucent polymer coating. The second portion of light that passes through the translucent polymer coating reflects the surface of the wheel defining a third portion of light.

### PRIOR APPLICATIONS

The present application claims priority to U.S. Provisional Patent Application No. 63/340,654 filed on May 11, 2022 the contents of which are incorporated herein by reference.

### TECHNICAL FIELD

The present invention relates to a vehicle wheel. More specifically, the present invention relates to a vehicle wheel having a translucent overcoat with tinting.

### BACKGROUND

Vehicle wheels are becoming much more than merely function vehicle parts. Vehicle wheels are increasingly becoming an important styling component of a vehicle. Significant scientific efforts are taken to achieve unique styling for a vehicle wheel while also providing requisite functionality. One important aspect of wheel styling is the wheel paint or coatings applied to the vehicle wheel. Modern coating systems generally make use of a colored base polymeric coating providing a desired hue that is covered with an outermost clear polymeric coating that is transparent to provide a desired gloss level. Various coating strategies have been implemented to provide differing wheel appearances. To date, these coating systems have proven difficult and costly to implement. However, unique and distinguishing appearances continue to be a focus for vehicle and vehicle wheel styling.

In each coating strategy a clear acrylic outermost coating is applied over alternative coating systems. In one coating system, an acrylic clear polymer is included as an outermost wheel coating. In most coating systems, a primer is applied to the wheel substrate followed by pigmented or colored base coat over which the acrylic clear polymer is applied. To provide further distinguishing appearance any of the following might be employed. A pigmented base coat is applied over the primer followed by application of a pigmented clear coat, and finally, application of the acrylic clear polymer. Alternatively, a low or mid gloss acrylic is applied over the acrylic clear polymer and constitutes the outermost clear coating. Still further, a pigmented base coat is applied over a primer followed by application of a polymeric clear coating then a pigmented clear coat, and finally, application of the acrylic clear polymer. A still further coating system includes pigmented base coat that is applied to the primer followed by a polymeric clear coat, a pigmented clear coat, an acrylic clear polymer and low or mid-gloss clear. Application of each of these coating layers requires a separate paint booth and a separate bake oven. Elimination of even one of these coating layers could significantly reduce manufacturing costs of a vehicle wheel.

A further coating strategy provides a glossy finish to the wheel by applying an acrylic clear coating directly to a milled alloy wheel substrate to establish a “bright shiny finish.” Alternatively, a pigmented clear is applied to the alloy wheel substrate followed by the acrylic clear coating. A still further alternative includes application of a pigmented clear being applied to the alloy wheel substrate followed by the acrylic clear coating and then application of a low or mid-gloss clear coating over the acrylic clear coating.

A still further coating strategy includes application of a PVD metal over a primer coating. In this coating system, an acrylic clear coating is applied directly over the PVD metal. Alternatively, a pigmented clear coating is applied directly to the PVD metal followed by application of the acrylic clear coating. A further alternative coating system includes a polymeric clear coat being applied directly to the PVD metal followed by application of a pigmented clear coating and then application of the acrylic clear coating. A still further alternative coating system includes pigmented clear coating being applied directly to the PVD metal followed by the acrylic clear coating and then a low or mid-gloss coating. A still further coating system includes a polymeric clear coat being applied directly to the PVD metal followed by application of a pigmented clear coating and then application of the acrylic clear coating and a low or mid-gloss coating.

The various systems discussed hereinabove all include deficiencies either related to inefficient and costly production or lack of distinctive visible characteristics. As set forth above, application of multiple layers of paint requires a same number of paint booths as there are layers. In each case, an outermost layer of clear polymeric coating that is completely transparent is applied to provide a desired gloss level. Facility costs are prohibitive to providing exotic multi-layer coatings that provide an appearance that is increasingly being sought by vehicle manufacturers and consumers. Therefore, there is a need for providing a simplified system for vehicle wheel coating applications by reducing the layers presently required to provided desired hue and gloss.

### SUMMARY

A vehicle wheel includes a face portion and rim portion defining a wheel surface. The face portion includes a plurality of spokes extending radially outwardly from a central portion to the rim portion interconnecting the face portion to the rim portion. A translucent polymer coating defines an outermost coating of the surface of the wheel where the translucent polymer coating is tinted for reflecting a first portion of light illuminating the wheel and allowing a second portion of light to pass through the translucent polymer coating. The second portion of light that partially passes through the translucent polymer coating and reflects off the surface of the wheel defining a third portion of light.

For the first time, a process is provided for vehicle wheel coatings that provide an exotic appearance while eliminating layers of coatings to reduce manufacturing cost. The translucent coating, while providing a desired gloss level also is lightly pigmented or dyed to provide a tint or hue to the outermost surface of the wheel. Previously, gloss and durability could only be provided by clear acrylic being applied as an outermost coating that eliminates the ability to provide a tint or hue. Further, by adjusting the hue or color of the translucent polymer coating, differing appearances are presented to an observer and even presents a three dimensional illusion when contrasted with differing base pigmentation or PVD metallic content. Moving the tinted clear coating to the outermost layer provides new and distinct appearance characteristics to the vehicle wheel while reducing manufacturing cost by eliminating an outermost layer of clear acrylic coating.

### BRIEF DESCRIPTION OF THE FIGURES

Other advantages of the present invention will be readily appreciated, as the same becomes better understood by reference to the following detailed description when considered in connection with the accompanying drawings, wherein:

FIG. 1 shows a perspective view of a vehicle wheel;

FIG. 2 shows a plan view of the vehicle wheel;

FIG. 3 shows a partial cross-sectional view of a coating system of the present invention having an outermost tinted translucent coating disposed over a pigmented base coat;

FIG. 4 shows a partial cross-sectional view of a coating system of the present invention having an outermost tinted translucent coating disposed over a machined alloy substrate;

FIG. 5 shows a partial cross-sectional view of a coating system of the present invention having an outermost tinted translucent coating disposed over a PVD metal; and

FIG. 6 shows reflective properties of a coating system of the present invention having an outermost tinted translucent coating.

### DETAILED DESCRIPTION

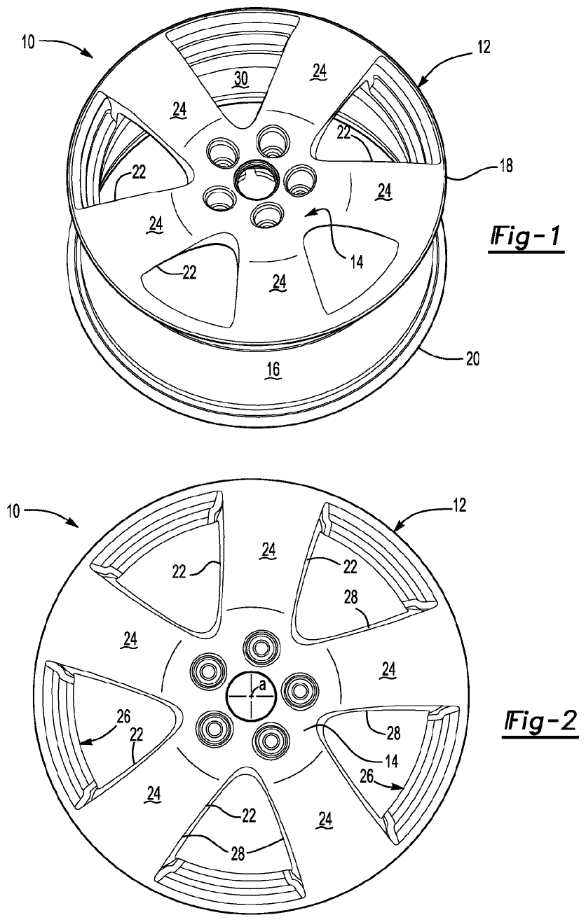

Referring to FIG. 1, a cast alloy wheel of the present invention is generally shown at 10. The wheel 10 is cast from an aluminum alloy, a magnesium alloy, a titanium alloy, or an equivalent alloy as is known to those of skill in the art. The wheel 10 includes a rim element 12 that defines an axis a (FIG. 2). A central element 14 extends radially outwardly between the axis a and the rim element 12. The rim element 12 defines a drop surface (or annular wall) 16 extending between a distal bead 18 and a proximal bead 20 at a location that is disposed radially inwardly from the two beads, 18, 20. It should be understood by those of ordinary skill in the art that the proximal bead 18 is located outboard of a motor vehicle (not shown) and the distal bead 20 is located inboard of the motor vehicle. Furthermore, the drop surface 16 is defined as a cylindrical surface circumscribing the axis a in a known manner.

Referring now to FIG. 2, the central element 14 includes a plurality of spokes 22. Each spoke 22 includes a face or primary surface 24. A secondary surface 26 extends axially toward the distal bead rearward from the primary surface 24. It should be understood that the secondary surface 26 includes all surfaces extending axially in the direction of the distal bead 18 that are visibly apparent. This includes opposing sidewalls 28 of the spokes 22 and inner annular wall surface 30. It should be understood by those of ordinary skill in the art that the configuration of the spokes 22 and of the central element 14 is merely exemplary and that a wide variety of spoke and central element configurations are included within the scope of this invention. Further, the primary surface 24 also includes the central element 14 in some embodiments.

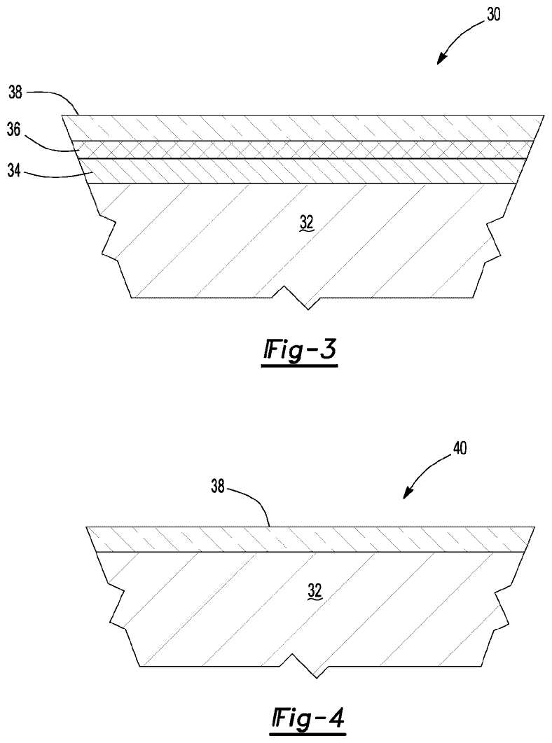

Referring to FIG. 3, a first embodiment of the coating system of the vehicle wheel 10 is shown with a first embodiment of the inventive coating system 30 of the present application. For brevity, reference is made throughout the present application to the face or primary surface 24 to describe the inventive coating system. However, it should be understood that the invent of coating system may also be applied to all visible surfaces of the wheel 10 when installed on a vehicle, including, the distal bead 18, the spokes 22, the secondary surface 26, the opposing sidewalls 28, and the inner annular wall surface 30. Alternatively, it should be understood that the inventive coating system may be applied only to one or any of the primary surface 24 of the wheel 10, the opposing sidewalls 28, and the portions of the inner annual wall surface 30 that are readily visible when the vehicle wheel 10 is installed on a vehicle.

In this first embodiment, an alloy substrate 32 that defines the primary surface 24 of the vehicle wheel 10 is coated with a polymer primer 34. The wheel substrate 12, in one embodiment, is an aluminum alloy. Alternatively, other alloys are within the scope of this invention including, but not limited to, magnesium, titanium, and any other lightweight alloy material providing physical properties required of a vehicle wheel. It should also be understood that composite or polymer substrates are also within the scope of this invention and also may be used with modified polymer primers 34.

The primer 34, in one embodiment, is an electrodeposition polymer used for providing corrosion resistant properties to the alloy substrate of the wheel 10. In addition, the primer 34 provides adhesion properties to the coating layer selectively applied after application of the primer 34. The primer 34 may also be applied by way of liquid or powder spray, or in combination with electrodeposition with a following spray application. In one embodiment, the primer 34 includes a film thickness of between 3.0 and 4.0 mils. However, it should be understood that a multiple layered primer system may include higher film thicknesses. Still further, it should be understood that a portion of the primer 34 may be removed by milling or laser ablation reducing film thickness or exposing the alloy substrate 32.

After the primer 34 is cured in a bake oven in a known manner, a base polymer coating 36 is applied over the primer 34. The base polymer coating 36 includes pigmentation for providing a desired hue or color to the wheel. For example, the base polymer coating 36 provides a solid color in a desired hue. Alternatively, the base polymer coating 36 includes metallic flake in combination with the pigment to present a colorized metallic aesthetic. The film thickness of the base polymer coating is between 0.08 and 0.12 mills. However, the film thickness may vary based upon type of pigmentation and selected polymer to provide desired coloration and durability to the coating system 10 of the wheel. In one embodiment, the base polymer coating 36 is a liquid polymer at the time of spray application. Alternatively, it is within the scope of this invention that the base polymer coating 36 it is a powder at the time of application. After application of the base polymer coating 36, the wheel is again subject to a bake oven for curing and polymerization of the resin defining the base polymer coating 36.

After the base polymer coating 36 has been cured, a translucent coating 38 is applied to the wheel over the base polymeric coating 36. In one embodiment, the translucent coating 38 is in the form of an acrylic powder at the time of application. Alternatively, the translucent coating 38 is a urethane, formed from either a one component reactive isocyanate or a two component reactive isocyanate. The film thickness of the cured translucent coating 38, in one embodiment, is between 3.0 and 6.0 mils. In alternative embodiments, the film thickness of the cured translucent coating 38 is between 3.0 and 4.0 mils. Still further, the film thickness of the cured translucent coating 38 is between 5.0 and 6.0 mils. The selected film thickness of the translucent coating 38 is selected upon desired visual effects and durability requirements as will be understood further hereinbelow.

The properties of the outermost translucent coating 38 may be modified to effect the overall aesthetics of the coating system 30. For example, the level of pigmentation of the translucent coating 38 may be selected to modify the amount a penetration of sunlight through the outermost translucent coating 18 to the base polymer coating 36. As used herein, “translucent” means partially transparent as defined by the amount of tinting provided to the outermost translucent coating 38 and “tinted” means colorization added to the outermost translucent coating 38 by way of pigment or dye. The amount of transparency may be modified by the amount of tinting by way of pigmentation or dye. The use of pigmentation to achieve a desired amount of tinting has proven more flexible, particularly for varying film thickness of the translucent polymer coating 38. In one embodiment, pigment accounts for about 20% by weight of the polymer resin forming the outermost translucent coating 38. Alternatively, less pigmentation gives the translucent coating 38 more transparency while more pigmentation gives the translucent coating 38 less transparency. When the translucent coating 18 is a powder coating, the pigmentation is believed to be equally distributed upon curing, even at very high film thicknesses of up to 6.0 mils although the pigment may not be evenly distributed in the powder prior to curing. As used herein, “outermost” means the last layer of coating applied to the wheel 10.

By modifying the polymer resin of the outermost translucent coating 38, adjustment may be made to the gloss level of the translucent coating 18 even when forming the outermost coating as explained herein. For example, the translucent coating maybe selected to present high-gloss, mid-gloss, or low-gloss properties. As such, it should be understood that when the translucent polymer coating 38 is the outermost coating, its reflectivity based upon gloss level is adjustable to provide different wheel appearances. Thus, a high gloss appearance will reflect more incident light than a mid-gloss or low-gloss finish.

A first alternative embodiment is generally shown at 40 of FIG. 4. In this embodiment, the translucent coating 38 is applied directly to the alloy substrate 32 of the wheel 10. In this embodiment, it is contemplated by the inventors that a polymer primer and/or polymer base coat is first applied to the wheel and then machined or milled at the primary surface 24 of the wheel 40 exposing a portion of the alloy substrate 32 at the face 24 of the wheel 10. Therefore, the outermost translucent coating 38 directly covers both the alloy substrate where the wheel 10 has been milled or machined and the polymer coating on, for example, the secondary surfaces 26 of the wheel 10 that have not been milled or machined. Therefore, the outermost translucent coating 38 is formulated to adhere to both the alloy substrate 32 and a polymeric primer or base polymeric coating. This embodiment presents a unique appearance by way of the translucent properties of the outermost translucent coating 38 between the alloy substrate 12 and the underlying polymer coating on the secondary surfaces 26. Where the translucent coating 38 is disposed over the alloy substrate 32, a shiny metallic appearance is presented as modified by the tint of the translucent coating 38. Where the translucent coating 38 is disposed over a pigmented basecoat or primer, the tint of the translucent coating 38 modifies the reflective coloration of the pigmented base coat or primer as explained hereinabove. It should be understood that the alloy surface where milled and even the polymer coating applied to the secondary surfaces 26 may be subject to plasma conversion as is disclosed in co-pending U.S. patent application Ser. No. 15/524,075 METHOD OF COATING ALLOY WHEELS and co-pending U.S. patent application Ser. No. 16/256,550 METHOD OF COATING ALLOY WHEELS USING INTER-COAT PLASMA, the contents each of which are included herein by reference.

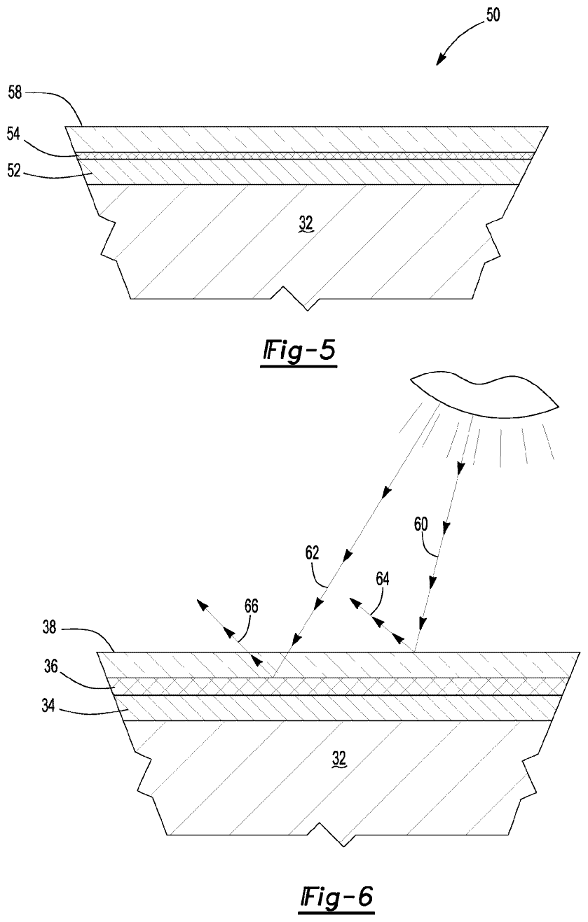

Referring now to FIG. 5, a still further embodiment of the coating system of the present invention is generally shown at 50. In this embodiment, a primer coating 52 is applied to the alloy wheel substrate 32. The primer coating 52 is particularly suited to receive a physical vapor deposition (PVD) metal layer 54 in a conventional manner. PVD as used herein is a process by which metal is applied over a polymer coating to present in metallic appearance. The thickness of the PVD metal 34 in one embodiment is about 0.3 mils. An outermost translucent coating 58 is applied directly over the PVD metal 54. In one embodiment, a portion of the PVD metal 54 is machined to expose the alloy substrate 32 of the wheel 10 to present a combination bright shiny substrate 32 and PVD metal appearance 54. Alternatively, no machining is performed, and the entire wheel presents the PVD metal 54 as modified by the tint of the outermost translucent coating 58. It should also be understood by those of skill in the art that portions of the PVD metal 54 could be removed by way of machining for exposing an underlying pigment polymer coating to present a two-tone appearance is modified by the tint of the outermost translucent coating 58. In an alternative embodiment, masking may be used to achieve a two-tone appearance. It should also be understood that the outermost translucent polymeric coating 58 is formulated to adhere to both the wheel substrate 12 and the PVD metal 54, including an addition of requisite ultraviolet light blockers. Examples of achieving a two-tone appearance are disclosed in U.S. Pat. No. 10,399,380, the contents of which are incorporated herein by reference.

Referring now to FIG. 6, an explanation of the ability of the outermost translucent coating 38 to modify the appearance of the coating or surface onto which the outermost translucent coating 38 is adhered is now provided. By way of non-limiting explanation, one embodiment of the present coating system is used in which the translucent coating 18 is partially tinted a first colorization by a first pigment and the base polymer coating 36 is made opaque with a second colorization by a second pigment. For example, the translucent coating 38 may be tinted with a blue pigment presenting a blue hue or colorization while the base polymer coating 36 is pigmented to present a red colorization. In this embodiment, sunlight irradiates a first portion of light 60 and a second portion of light 62. The first portion of light 54 reflects off the outermost translucent coating 38 thereby reflecting a third portion 64 of light having red coloration 58 or hue. The second portion of light 62 passes through the outermost translucent coating 38 reflecting from the blue pigmentation of the base polymeric coating 36 presenting a forth portion 66 of light having a blue coloration. Therefore, the wheel presents a three-dimensional appearance whereby blue colorization 66 may be observed beneath a red tinted colorization 64. The three dimensional appearance may be modified by the film thickness for the outermost translucent coating 38 and the amount of tinting included therein. Further, the angle by which the sunlight irradiates the translucent polymeric coating 38 may affect the amount of red colorization 64 or blue colorization 66 that is perceived because the tinting is disposed in the outermost coating 38.

Multiple combinations of tinting and coloration may be achieved including providing metallic flake within the outmost translucent coating 38 or combinations of colored tint, metallic flake in both the translucent coating 38 and the base polymer coating 36. In the one embodiment, the tinting of the translucent coating 38 is different than the pigmentation of the base polymer coating 36 to achieve a contrasting appearance to the coating system 30, 40, 50. In another embodiment, the tinting of the translucent coating 18 is the same color as the pigmentation of the base polymer coating 16 to provide depth to the coloration of the coating system 30, 40, 50.

Additional distinguishing characteristics may also be achieved to the vehicle wheel that take advantage of the benefits translucent coating 38 of the present invention that are set forth above. In one embodiment, and applique may be applied to the surface directly beneath the translucent coating 38 in a manner of set forth in co-pending U.S. patent application Ser. No. 17/510,595 DECORATIVE APPLIQUE WITH POLYMERIC OVER-COATING AND METHOD OF APPLYING SAME, the contents of which are included herein by reference. In this embodiment, the applique presents an icon or other branding feature what is modified by the tinting and film thickness of the translucent coating 38. Combinations of PVD metal, wheel substrate, variants of pigments polymeric base coatings, and laser ablation of any of these may be implemented to provide alternative and variable appearances to the face or central element of the wheel, and any other portion of the wheel.

A still further embodiment includes the process of pad printing of which graphics are printed upon the base polymer coating 36. After pad printing, the translucent coating 18 is applied over the printed graphics and the base polymer coating 36, again resulting in a unique three-dimensional appearance.

It should be understood that a plurality of different basecoat technologies may be implemented to achieve both economic value and unique appearance. For example, new technologies combine desired pigmentation in a single basecoat/primer layer. Furthermore, additional technology to improve performance of the coating system 30, 40, 50 such as plasma treatment and dry conversion may be implemented as explained hereinabove.

The invention has been described in an illustrative manner, and it is to be understood that the terminology that has been used is intended to be in the nature of words of description rather than of limitation. Obviously, many modifications and variations of the present invention are possible in light of the above teachings. It is therefore to be understood that within the specification, the reference numerals are merely for convenience, and are not to be in any way limiting, the invention may be practiced otherwise than is specifically described.

What is claimed is:

1. A vehicle wheel, comprising:
a face portion and rim portion defining a wheel surface, said face portion including a plurality of spokes extending radially outwardly from a central portion to said rim portion thereby interconnecting the face portion to said rim portion;
a translucent polymer coating defining an outermost coating of said surface of said wheel whereby said translucent polymer coating is tinted for receiving a first portion of light illuminating said vehicle wheel reflecting a second portion modified by said tint and allowing a second portion of light to pass therethrough; and
said second portion of light being transmissible through said translucent polymer coating and reflecting from said surface of said wheel thereby defining a fourth portion of light.

2. The wheel set forth in claim 1, wherein said translucent polymer coating is adhered to an alloy substrate defining said surface of said vehicle wheel.

3. The wheel set forth in claim 1, wherein said translucent polymer coating is adhered to base polymer layer defining said surface of said wheel with said base polymer layer being pigmented.

4. Th wheel set forth in claim 1, wherein said translucent polymer coating is adhered to a PVD metal layer defining said surface of said vehicle wheel.

5. The wheel set forth in claim 1, wherein said translucent polymer coating is adhered to at least one of a base polymer layer and said alloy substrate.

6. The wheel set forth in claim 1, wherein said translucent polymer coating is adhered to at least one of a PVD metal layer and said alloy substrate.

7. The wheel set forth in claim 1, wherein said translucent polymer coating includes a thickness of between three and six mils.

8. The wheel set forth in claim 1, wherein said translucent polymer coating comprises a powder coating material being pigmented thereby providing a translucent colored polymer coating.

9. The wheel set forth in claim 1, comprising a base polymeric coating over which said translucent polymer coating is applied and said translucent polymer coating is tinted a first hue and the base coating is pigmented with a second hue.

10. The wheel set forth in claim 1, comprising a base coating over which said translucent polymer coating is applied, and said translucent polymer coating and the base coating is pigmented a same hue.

11. The wheel set forth in claim 1, wherein at least one of said translucent polymer coating and a base coating include metallic flake.

12. The wheel set forth in claim 1, wherein said translucent polymer coating includes a film thickness of between three mils and five mils.

13. The wheel set forth in claim 1, wherein said second portion of light defines a first hue and said fourth portion of light defines a third hue.

14. The wheel set forth in claim 1, wherein said outermost translucent polymer coating is defined by one of a high gloss, a medium gloss and a low gloss.

15. The wheel set forth in claim 1, wherein said outermost translucent coating comprises about 20% by weight of the polymer resin of pigment.
